(19) United States
(12) Patent Application Publication
(10) Pub. No.: US 2001/0016186 A1
(43) Pub. Date: Aug. 23, 2001

(54) Carbon material comprising particles having a coarsely granular surface and process for the production thereof

(76) Inventors: Hitoshi Sakamoto, Tsukuba-shi (JP); Koichi Kanno, Tsukuba-shi (JP); Hirotaka Tsuruya, Tsukuba-shi (JP); Yukio Sakai, Kurashiki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/788,581

(22) Filed: Feb. 21, 2001

(30) Foreign Application Priority Data
Feb. 21, 2000 (JP) 42185/2000

(51) Int. Cl. C01B 31/02

(52) U.S. Cl. 423/445 R; 208/39

(57) ABSTRACT

A carbon material comprising particles having a coarsely granular surface, which material contains mesophase pitch as a main raw material, has at least two granular carbonaceous projections having a diameter not more than a minimum particle diameter on a particle surface and has an oxygen content of 0.1% by weight or more and a process for the production thereof.

### FIELD OF TH INVENTION

The present invention relates to a carbon material having an especial shape for use as a raw material for a variety of carbon material products and a process for the production thereof.

### DESRIPTION OF THE PRIOR ARTS

Carbon material products are utilized in remarkably broad regions, that is, they are utilized for electrochemistry such as a fuel cell or an electrode for electro-dischage machining, electricity such as a current collector, metallurgy such as a crucible or a boat material, and machines such as sealing and further utilized for a nuclear reactor, activated carbon and the like. Therefore, developments thereof are further proceeded.

Conventionally, carbon material products are usually produced by mixing an aggregate coke with a binder and molding, calcinating or graphitizing the mixture. In this case, the mixing of the aggregate coke and the binder complicates working steps and worsens a working environment. In addition, since the aggregate coke itself is porous and since coal tar pitch or synthetic resins used as a binder cause many pores during the calcinating, it is difficult to produce a high-density carbon material product.

Under the above circumstances, the production of a high-density carbon material without using a binder is under study. As a method of producing a high-density carbon material without a binder, JP-B-60-25364 discloses a method comprising heat-treating coal tar pitch, separating optically anisotropic small spheres with a solvent in the above heat-treatment step, and then, calcinating the optically anisotropic small spheres under an inert gas atmosphere. JP-B-1-27968 discloses a method comprising separating a solid matter from a reaction product obtained by heat-treating coal tar with a centrifugal separator and washing the solid matter to produce fine carbon particles. JP-B-3-61604 discloses a method comprising heat-treating coal tar pitch, carrying out an extraction with a solvent, carrying out a filtration and calcinating insolubles under an inert gas atmosphere.

Further, JP-A-7-286181 discloses a use of a sloped reactor for continuously producing a granular or powdery heat-treated product such as pitch or heavy oil.

Conventional production methods of a high-density carbon material can give optically anisotropic small spheres (mesophase carbon micro beads) or fine carbon particles. In these methods, however, a great deal of thermal energy is required and steps of separating and washing are complicated. Therefore, these methods are industrially disadvantageous. Further, since spheric materials have a small specific surface area, it is difficult to mold the spheric materials so that it is difficult to obtain a high-density carbon material. Furthermore, fine carbon particles involves dusting to a large extent, which worsen handling properties, and it is therefore difficult to efficiently obtain a high-density carbon material.

The present inventors have made diligent studies with regard to a carbon material having the above problems. As a result, it is found that a carbon material comprising particles having a coarsely granular surface is easily obtained by stirring precedently-heated carbonaceous particles and adding mesophase pitch in driblets under a slightly-oxidizing atmosphere. The carbon material comprising particles having a coarsely granular surface is almost free from dusting and excellent in handling properties so that a carbon material product can be efficiently produced.

### SUMMARY OF THE INVENTION

It is an object of the present invention to provide a carbon material having a shape suited for effectively obtaining a variety of carbon material products and a process for the production thereof.

According to the present invention, there is provided a carbon material comprising particles having a coarsely granular surface, which material contains mesophase pitch as a main raw material, has at least two granular carbonaceous projections having a diameter not more than a minimum particle diameter on a particle surface and has an oxygen content of 0.1% by weight or more.

According to the present invention, further, there is provided a process for the production of a carbon material comprising particles having a coarsely granular surface, comprising heating carbonaceous particles up to 200 to 600° C. under an inert gas atmosphere with stirring, then, changing the inert gas atmosphere to a slightly-oxidizing atmosphere containing at least 0.1% by mole of oxygen and/or No₂, then, adding mesophase pitch in a solid state or a molten state into the carbonaceous particles during the stirring, and continuing stirring the mixture with maintaining a temperature in the above temperature range.

According to the present invention, there is provided a process for the production of a carbon material comprising particles having a coarsely granular surface according to the above invention, wherein the carbon material comprising particles having a coarsely granular surface is continuously produced by continuing adding the mesophase pitch.

According to the present invention, further, there is provided a process for the production of a carbon material comprising particles having a coarsely granular surface according to the above invention, wherein the carbon material comprising particles having a coarsely granular surface is continuously produced by continuing adding the carbonaceous particles together with the continuous addition of the mesophase pitch.

According to the present invention, further, there is provided a process for the production of a carbon material comprising particles having a coarsely granular surface according to the above invention, wherein the carbonaceous particles are carbonaceous particles produced from the mesophase pitch.

According to the present invention, further, there is provided a process for the production of a carbon material comprising particles having a coarsely granular surface according to the above invention, wherein the carbonaceous particles are formed of a carbonaceous substance which is not molten at a temperature other than a temperature where the mesophase pitch is produced.

### BRIEF DESCRIPTION OF THE DRAWINGS

FIG. 1 shows an example of a batch reactor used for producing the carbon material comprising particles having a coarsely granular surface, provided by the present invention.

FIG. 2 shows an example of a continuous reactor used for producing the carbon material comprising particles having a coarsely granular surface, provided by the present invention.

FIG. 3 shows a scanning electron micrograph of the carbon material comprising particles having a coarsely granular surface, obtained in Example 1.

### DETAILED DESCRIPTION OF THE INVENTION

The mesophase pitch used as a raw material in the present invention can be selected from petroleum pitch, coal pitch or synthetic pitch. Of these, there is preferably used synthetic pitch obtained by polymerizing a condensed polycyclic aromatic hydrocarbon such as naphthalene, methylnaphthalene, anthracene, phenanthrene, acenaphthene, acenaphthylene or pyrene, or a raw material containing a fused polycyclic hydrocarbon in the coexistence of hydrogen fluoride and boron trifluoride. The above mesophase pitch preferably has a softening point of at least 150° C. according to a flow tester method and an optically anisotropic content of at least 50% according to observation with a polarizing microscope.

The carbon material comprising particles having a coarsely granular surface, provided by the present invention, is produced by stirring precedently-heated carbonaceous particles and adding the above mesophase pitch in driblets thereto under a slightly-oxidizing atmosphere. The carbonaceous particles to be used include not only carbonaceous particles derived from the mesophase pitch but also natural products such as coconut shell charcoal or wood charcoal or carbonaceous particles which are not molten at a production temperature such as resin charcoal or coke.

The carbonaceous particles used for producing the carbon material comprising particles having a coarsely granular surface, provided by the present invention, have a particle diameter of 30 to 1,000 μm, preferably 100 to 600 μm. The heating temperature applied when the carbonaceous particles are stirred differs depending upon the kind of the carbonaceous particles to be used, while it is generally 200 to 600° C., preferably 300 to 500° C., under normal pressure.

The concentration of oxygen in a slightly-oxidizing atmosphere when the mesophase pitch is added is at least 0.1% by mole, preferably 1 to 25% by mole.

As a gas for the slightly-oxidizing atmosphere, there is preferably used a nitrogen gas or argon gas containing at least 0.1% by mole of oxygen or NO₂. Further, there can be used a gas prepared by diluting air, oxygen or NO₂ with a gas such as nitrogen, argon or carbon dioxide.

When the mesophase pitch is added to heated and stirred carbonaceous particles under such a slightly-oxidizing atmosphere, a carbon material obtained is converted to an infusible carbon material, whereby there is obtained a carbon material comprising particles having a coarsely granular surface which material is almost free from dusting and excellent in handling properties.

The oxygen content in the carbon material comprising particles having a coarsely granular surface, provided by the present invention, is at least 0.1% by weight, preferably 0.3 to 15% by weight.

In the production process of the carbon material comprising particles having a coarsely granular surface, provided by the present invention, the carbon material comprising particles having a coarsely granular surface can be produced by newly adding carbonaceous particles together with the mesophase pitch during its production. The carbonaceous particles to be added are not limited to those carbonaceous particles which are derived from mesophase pitch, and carbonaceous particles which are not molten at a production temperature can be selected depending upon a use as required. In this case, when carbonaceous particles which are not derived from mesophase pitch are added, there is obtained a carbon material comprising particles having a coarsely granular surface which material is composed of the above carbonaceous particles and the mesophase pitch. When only the addition of the mesophase pitch is continued and no carbonaceous particles are newly added, there is finally obtained a carbon material comprising particles having a coarsely granular surface which material is entirely derived from the mesophase pitch. In this case, when mesophase pitch containing little impurities is used as a raw material mesophase pitch, there can be obtained a remarkable high-purity carbon material comprising particles having a coarsely granular surface so that steps to follow, such as decarbonization, can be omitted.

As a reactor used for producing the carbon material comprising particles having a coarsely granular surface, there is used a reactor which can fully stir carbonaceous particles. In a batch method, a tank type reactor (e.g., a tank type sloped reactor disclosed in JPA-7-286181) is used as the above reactor. And in a continuous method, a barrel type reactor comprising paddles or a rotary kiln is used.

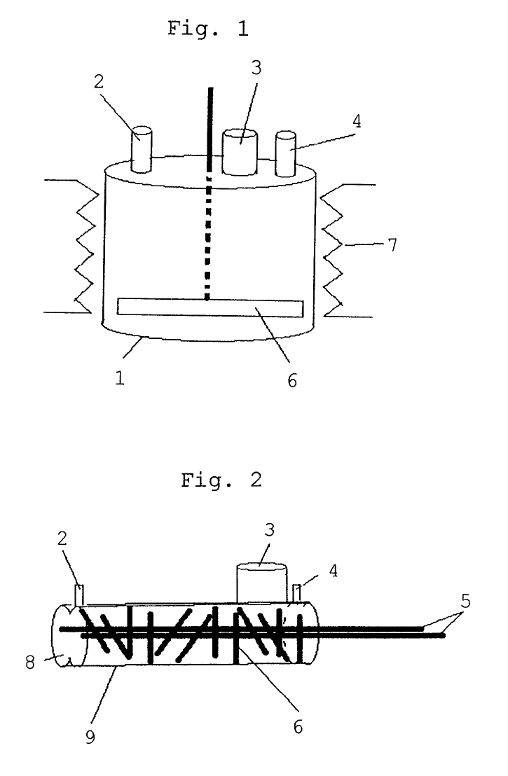

FIG. 1 shows a batch reactor used for producing the carbon material comprising particles having a coarsely granular surface, provided by the present invention. The carbon material comprising particles having a coarsely granular surface is produced by precedently heating carbonaceous particles, introducing a slightly-oxidizing atmosphere thereto and adding mesophase pitch and optional carbonaceous particles from the top portion while stirring with stirring paddles.

FIG. 2 shows a continuous reactor comprising a barrel type reactor. The barrel type reactor has a sloped structure in which the upstream side is the lower side and an opening for atmosphere gas introduction and an opening for intake of mesophase pitch and carbonaceous particles are disposed at the upstream side. While the mesophase pitch and the carbonaceous particles or the mesophase pitch alone pass(es) through the barrel type reactor with being stirred with stirring paddles, the carbon material comprising particles having a coarsely granular surface is produced.

Symbols in drawings have the following meanings; 1: a tank type reactor, 2: an outlet for exhaust gas, 3: an opening for intake of carbonaceous particles and mesophase pitch, 4: an opening for introducing an atmosphere gas, 5: rotating shafts, 6: stirring paddles, 7: an electrical heater, 8: a products outlet and 9: a barrel type reactor.

According to the method of the present invention, mesophase pitch as a raw material is molten on a carbonaceous particle surface, increased in viscosity and made infusible, whereby a carbon material comprising particles having a coarsely granular surface is formed. The above melting, the increase in viscosity and the impartment of infusibility are carried out at the same time or successively depending upon the pitch to be used. In either case, there is obtained a homogenous carbon material. Further, the particle diameter of a carbon material ?? to be produced can be freely controlled by properly selecting the particle diameter of carbonaceous particles, the addition rate of mesophase pitch, and the rate of stirring. Therefore, the features of the present production process are as follows. A carbon material comprising particles having a coarsely granular surface can be directly produced by a continues method or a batch method without using any special shaping method. Further, the particle diameter can be freely controlled in production, and there can be produced a carbon material comprising particles having a coarsely granular surface which material has a uniform particle diameter distribution.

The carbon material comprising particles having a coarsely granular surface, provided by the present invention, is already substantially insoluble in a solvent when it is produced, and the carbon material of the present invention is not molten by heating it. The carbon material of the present invention can be used as it is depending upon a use. Otherwise, it can be used after calcination and graphitization. Treatments for the carbon material of the present invention after its production can be freely selected depending upon a purpose.

The carbon material comprising particles having a coarsely granular surface, provided by the present invention, is free from powdering and dusting and is excellent in handling properties. In addition, due to its large specific surface area, the carbon material comprising particles having a coarsely granular surface, provided by the present invention, has a practicable shape and practicable physical properties as raw material for a variety of carbon material products. Therefore, a variety of carbon material products can be produced effectively.

Further, according to the production process of the present invention, it is possible to easily produce a carbon material comprising particles having a coarsely granular surface with controlling the shape and the particle diameter thereof.

Therefore, the present invention is industrially remarkably excellent, and the present invention has significant industrial values.

### EXAMPLES

The present invention will be explained more in detail with reference to Examples hereinafter, while the present invention shall not be limited to these.

### Example 1

Mesophase pitch (softening point: 230° C., optically anisotropic content 100% by weight) obtained by polymerizing naphthalene in the coexistence of hydrogen fluoride and boron trifluoride was heat-treated at 530° C. under a nitrogen atmosphere, to obtain carbonaceous particles (average particle diameter 100 μm). 200 g of the carbonaceous particles were placed in a tank type reactor having a diameter of 200 mm and a height of 200 mm, shown in FIG. 1, and heated up to 450° C. under a nitrogen atmosphere with stirring. Then, the nitrogen atmosphere was changed to an air atmosphere. Mesophase pitch prepared in a pellet state so as to have a diameter of 1.5 mm and a length of 5 mm in advance was added thereto at a rate of 10 g per minute until 300 g of the mesophase pitch was added. After the completion of addition, the atmosphere was changed to a nitrogen atmosphere, and the heater was turned off, to cool the contents. The contents were taken out, to obtain 500 g of a carbon material comprising particles having a coarsely granular surface and having an average particle diameter of 2.5 mm.

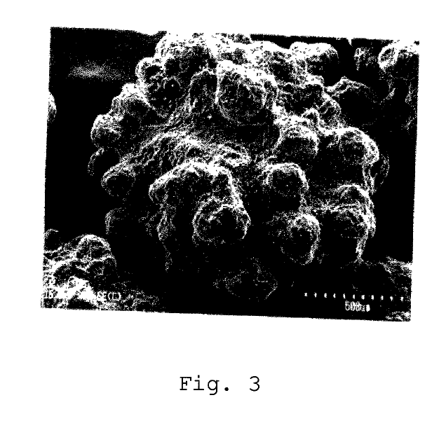

The so-obtained carbon material had an oxygen content of 13% by weight. When the carbon material was shaken in a sample tube, the carbon material showed no powdering and no dusting. The carbon material was excellent in fluidity. FIG. 3 shows a scanning electron micrograph of the carbon material.

### Example 2

Example 1 was repeated except that the air atmosphere was replaced with a nitrogen atmosphere containing 0.5% by mole of oxygen. As a result, there was obtained 450 g of carbon material comprising particles having a coarsely granular surface and having an average particle diameter of 3 mm. The carbon material had an oxygen content of 0.5% by weight. When the carbon material was shaken in a sample tube, the carbon material showed no powdering and no dusting. The carbon material was excellent in fluidity.

### Example 3

Example 2 was repeated except that the addition rate of the mesophase pitch in a pellet state was changed to 5 g per minute. As a result, there was obtained 440 g of a carbon material comprising particles having a coarsely granular surface and having an average particle diameter of 1.5 mm. The carbon material had an oxygen content of 5% by weight. When the carbon material was shaken in a sample tube, the carbon material showed no powdering and no dusting. The carbon material was excellent in fluidity.

### Example 4

Example 1 was repeated except that the air atmosphere was replaced with nitrogen containing 5% of NO₂. As a result, there was obtained 440 g of a carbon material comprising particles having a coarsely granular surface. The carbon material had an oxygen content of 8% by weight. When the carbon material was shaken in a sample tube, the carbon material showed no powdering and no dusting. The carbon material was excellent in fluidity.

### Example 5

Example 1 was repeated except that the treatment temperature was changed from 450° C. to 550° C. As a result, there was obtained 470 g of a carbon material comprising particles having a coarsely granular surface and having an average particle diameter of 2.5 mm. The carbon material had an oxygen content of 10% by weight. When the carbon material was shaken in a sample tube, the carbon material showed no powdering and no dusting. The carbon material was excellent in fluidity.

### Example 6

Mesophase pitch (softening point: 230° C., optically anisotropic content 100% by weight) obtained by polymerizing naphthalene in the coexistence of hydrogen fluoride and boron trifluoride was heat-treated at 530° C. under a nitrogen atmosphere, to obtain carbonaceous particles having an average particle diameter of 100 μm.

200 g of the carbonaceous particles was placed in a barrel type reactor composed of two cylinders having a diameter of 150 mm and a length of 600 mm each, shown in FIG. 2, and the carbonaceous particles were heated up to 550° C. under a nitrogen atmosphere with stirring. Then, the atmosphere was changed to an air atmosphere, and mesophase pitch prepared in a pellet state so as to have a diameter of 1.5 mm and a length of 5 mm in advance was added at a rate of 10 g per minute.

While the mesophase pitch was continuously added, the reaction system was continuously operated at a treatment temperature of 550° C. for eight hours. As a result, a carbon material comprising particles having a coarsely granular surface and having an average particle diameter of 2 mm was ejected at a rate of 9 g per minute. The so-obtained carbon material had an oxygen content of 12% by weight. When the carbon material was shaken in a sample tube, no powdering and no dusting were observed. The carbon material was excellent in fluidity.

### Example 7

A carbon material comprising particles having a coarsely granular surface was produced in the same manner as that in Example 6 except that the treatment temperature was changed from 550° C. to 350° C. and that the operation period of time was changed from eight hours to six hours. As a result, there was ejected a carbon material comprising particles having a coarsely granular surface and having an average particle diameter of 3 mm at a rate of 9.5 g per minute. The carbon material had an oxygen content of 13% by weight. When the carbon material was shaken in a sample tube, the carbon material showed no powdering and no dusting. The carbon material was excellent in fluidity.

### Comparative Example 1

Example 1 was repeated except that the air atmosphere was replaced with a nitrogen atmosphere. As a result, the pitch which was added was molten and integrated with the carbonaceous particles which were placed in advance, so that the treatment could not be carried out.

### Comparative Example 2

Example 6 was repeated except that the air atmosphere was replaced with a nitrogen atmosphere. As a result, obtained carbonaceous particles involved spherical particles and crushed particles and the carbonaceous particles showed a large particle size distribution.

What is claimed is:

1. A carbon material comprising particles having a coarsely granular surface, which material contains mesophase pitch as a main raw material, has at least two granular carbonaceous projections having a diameter not more than a minimum particle diameter on a particle surface and has an oxygen content of 0.1% by weight or more.

2. A carbon material according to claim 1, wherein the mesophase pitch is petroleum pitch, coal pitch or synthetic pitch.

3. A carbon material according to claim 1, wherein the mesophase pitch is obtained by polymerizing a condensed polycyclic aromatic hydrocarbon or a material containing a condensed polycyclic aromatic hydrocarbon in the coexistence of hydrogen fluoride and boron trifluoride.

4. A carbon material according to claim 1, wherein the mesophase pitch has a softening point of at least 150° C. according to a flow tester method and an optically anisotropic content of at least 50%.

5. A carbon material according to claim 1, wherein the carbon material comprising particles having a coarsely granular surface is composed of the mesophase pitch and carbonaceous particles which are not molten at a temperature other than a temperature where the mesophase pitch is produced.

6. A carbon material according to claim 1, wherein the carbon material comprising particles having a coarsely granular surface is composed of the mesophase pitch and carbonaceous particles obtained from the mesophase pitch.

7. A carbon material according to claim 1, wherein the carbon material comprising particles having a coarsely granular surface is composed of the mesophase pitch.

8. A process for the production of a carbon material comprising particles having a coarsely granular surface, comprising heating carbonaceous particles up to 200 to 600° C. under an inert gas atmosphere with stirring, then, changing the inert gas atmosphere to a slightly-oxidizing atmosphere containing at least 0.1% by mole of oxygen and/or No₂, then, adding mesophase pitch in a solid state or a molten state into the carbonaceous particles during the stirring, and continuing stirring the mixture with maintaining a temperature in the above temperature range.

9. A process according to claim 8, wherein the carbon material comprising particles having a coarsely granular surface is continuously produced by continuing adding the mesophase pitch.

10. A process according to claim 8, wherein the carbon material comprising particles having a coarsely granular surface is continuously produced by continuing adding the carbonaceous particles together with the continuous addition of the mesophase pitch.

11. A process according to claim 8, wherein the carbonaceous particles are carbonaceous particles produced from the mesophase pitch.

12. A process according to claim 8, wherein the carbonaceous particles are formed of a carbonaceous substance which is not molten at a temperature other than a temperature where the mesophase pitch is produced.

13. A process according to claim 8, wherein the carbonaceous particles have an average particle diameter of 30 to 1,000 μm.
